(19) United States
(12) Patent Application Publication
(10) Pub. No.: US 2008/0097881 A1
(43) Pub. Date: Apr. 24, 2008

(54) Wealth Management Education System and Method

(76) Inventor: Jen-Her Jeng, Linnei Township (TW)

Correspondence Address: LAW OFFICES OF LAI & ASSOCIATES, P.C., STE 200, 5800 RANCHESTER, HOUSTON, TX, 77036, US

(21) Appl. No.: 11/758,323

(22) Filed: Jun. 5, 2007

(30) Foreign Application Priority Data
Oct. 20, 2006 (TW) 095138834

(51) Int. Cl. G06Q 40/00; G06F 17/30; G06F 17/40; G06F 3/01

(52) U.S. Cl. 705/35; 707/104.1; 715/700

(57) ABSTRACT

A wealth management education system and method thereof includes a storage unit, an input unit, an event selection unit and an ROI computation unit. The storage unit containing historical data of multiple capital markets, correlation matrices among those market, and multiple economic events. A user uses the input unit to enter sum of investment into those capital markets to trigger off a selection of one economic event according to a selection criterion. The ROI computation unit solves respective ROI of those capital markets according to the selected economic event, historical data and correlation matrices of those capital markets.

### BACKGROUND OF THE INVENTION

(a) Field of the Invention

The present invention is related to a wealth management education system and a method thereof, and more particularly, to one for training an investor to develop skills required in making investments in multiple capital markets.

(b) Description of the Prior Art

So far, financing has become an important skill that more and more people would like to learn. Some training systems may provide investors to practice their skills in making investment. For example, U.S. Pat. No. 7,040,982 teaches a business trading game for user to practice skills of how to observe market trends and make investment by following a roadmap of a simulated capital market. However, as the capital market is heading to globalization and international scale, different capital market are getting highly correlated to one another while those economic events affecting market fluctuations are getting diversified. Conventional training systems for making investments is not sufficient to provide sufficient skills for its users.

The inventor, having been engaged in the research and development of financial investment and hands-on experience for years, discloses a wealth management education system and method to bring a total solution for coping with those deficiencies as described above.

### SUMMARY OF THE INVENTION

The primary purpose of the present invention is to provide a wealth management education system and a method thereof for training an investor to develop skills to make investments in multiple capital markets.

To achieve the purpose, the present invention includes a storage unit, an input unit, an event selection unit, and a return of investment (ROI) computation unit. The storage unit stores historical data of multiple capital markets, correlation data among those capital markets, and data of multiple economic events. The input unit allows a user to enter the sum of investment to be made in those capital markets. The event selection unit selects an economic event from those economic events according to a selection criterion. The ROI computation unit based on the selected economic event, historical data of those capital markets, and correlation data among those capital markets to solve ROI and amount of return by market.

The present invention also discloses a wealth management education method including the following steps: historical data of multiple capital markets, correlation data among those capital markets, and data of multiple economic events are provided; sum of investment for those capital markets are inputted; an economic event is selected out of those economic events according to a selection criterion; ROI and amount of return of each of those capital markets are then solved according to the selected economic event, historical data of those capital markets, and correlation data among those capital markets.

### BRIEF DESCRIPTION OF THE DRAWINGS

FIG. 1 is a schematic view of a wealth management education system of the present invention;

FIG. 2 is schematic view of a visualized user interface of a preferred embodiment of the present invention;

FIG. 3 is schematic view of a visualized user interface of another preferred embodiment of the present invention; and

FIG. 4 is a flow chart showing a process of the present invention.

### DETAILED DESCRIPTION OF THE PREFERRED EMBODIMENTS

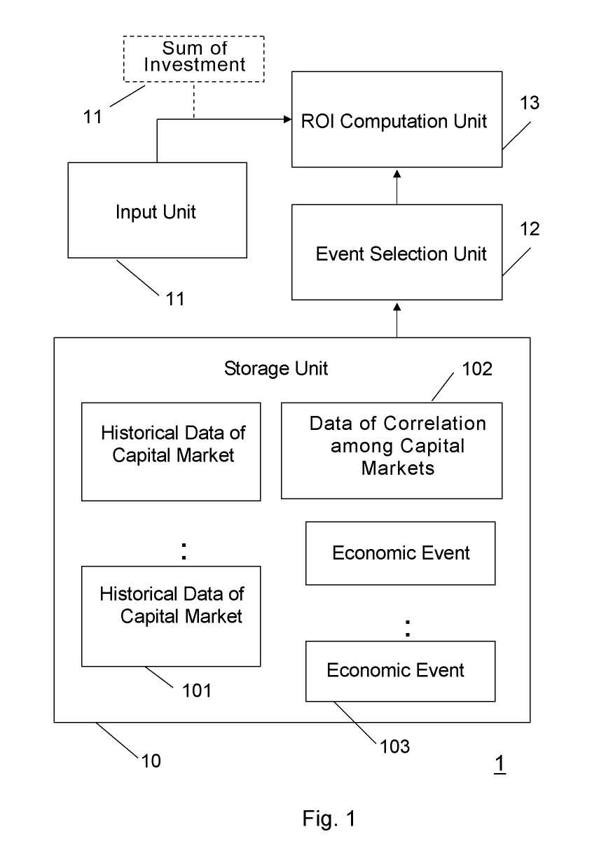

Referring to FIG. 1, a wealth management education system 1 of the present invention includes a storage unit 10, an input unit 11, an event selection unit 12, and a return on investment computation unit 13. The storage unit 10 stores historical data 101 of multiple capital markets, correlation data 102 among those capital markets, and data of multiple economic events 103. The input unit 11 allows a user to enter the sum of investment 111 to be made in those capital markets. The event selection unit 12 selects an economic event from those economic events 103 according to a selection criterion.

Those multiple capital markets are preferred to include stock market, bonds markets, foreign exchange markets, raw material markets, and/or real estate markets. Their historical data 101 are preferred to include those from representative capital markets, e.g., that of SP500 to represent historical data of stock market; 10-year US Government bond to represent historical data of bonds market; and US Dollars Index to represent historical data of the foreign exchange market.

Those economic events 103 are preferred to include weather events, e.g., mining disaster, typhoon, heat wave, flooding, or draught; political events, e.g., election, coup d'etat, terrorist attack; monetary/economic events, e.g., interest rate rise by FOMC, oil price soaring, or publishing financial statements by leading companies in each industry; psychological factors or strategic factors, e.g., Soros hot money, expectations from the market environment by the general public, speculators, or investors that may result in fluctuations in those capital markets.

The selection criterion is preferred to include selection of certain events out of those economic events 103 at random or pseudo-randomly. Before selecting an event pseudo-randomly, several pre-selected economic events are first selected from those economic events 103; and an economic event is then selected at random from those pre-selected economic events. Preemptive conditions for selecting the event pseudo-randomly may be defined by season, time, or month. For example, if the simulated season executed by the system is summer, item of “typhoon striking” from weather events of typhoon will have a better chance to be selected as a pre-selected economic event. The wealth management education system may further include a visualized user interface as applicable to provide its user to operate the wealth management education system 1.

The ROI computation unit 13 based on the economic event 14 selected, historical data 101 of those capital markets, and correlation data 102 among those capital markets solves ROI for each of those capital markets. Wherein, the ROI computation unit 13 first solves historical ROI of each of those capital markets based on their historical data 101; and then based on the correlation data 102 as adjusted by the selected economic event 14, those historical ROI and correlation data as adjusted are computed to solve the ROI for each capital market.

Correlation data 102 are preferred to include a matrix of correlation parameters. Table 1 shows an example of a matrix of correlation parameters of stock market, bond market, and foreign exchange market.

TABLE 1
$\begin{matrix} & S & B & FE \\ S & 1 & - 0.53 & 0.17 \\ B & - 0.53 & 1 & - 0.81 \\ FE & 0.17 & - 0.81 & 1\end{matrix} ( )$

In Table 1, ROI of the stock market indicates a negative correlation with ROI of the bond market, and a positive correlation with the ROI of the exchange market. According to historical data and field experience, the investor will dump bonds to increase chips on the stock market when the ROI of the stock market increases; in turn, the ROI on bonds drops. On contrary, once the ROI of the stock market falls, the investor will dump stocks for reinvesting in bonds provided with lower risks of investment. Therefore, the stock market and the bond market is negatively correlated, and thus the correlation parameter is of a negative value. According to the matrix, the ROI of the stock market is solved as follows:

ROI of Stock Market=Historical ROI of Stock Market+Historical ROI of the Bond×(−0.53)+Historical ROI of Foreign Exchange Market×(0.17);

ROI of Bond Market=Historical ROI of Stock Market×(−0.53)+Historical ROI of the Bond+Historical ROI of Foreign Exchange Market×(−0.81); and

ROI of Foreign Exchange Market=Historical ROI of Stock Market×(0.17)+Historical ROI of the Bond×(−0.81)+Historical ROI of Foreign Exchange Market.

The ROI computation unit 13 may adjust any parameter appearing in Table according to the selected economic event 14. For example, if the selected economic event 14 is related to “energy price soaring”, the matrix of Table 1 is then adjusted to that as shown in Table 2 below:

TABLE 2
$\begin{matrix} & S & B & FE \\ S & 1 & 0.8 & 0.3 \\ B & 0.8 & 1 & 0.6 \\ FE & 0.3 & 0.6 & 1\end{matrix} ( )$

When the energy price soars, the investor for expecting that inflation will get out of hand according to historical data and filed experience will dump both of stocks and bonds making both stock market and bond market to slump. Therefore, positive correlation turns out between the stock market and the bond market. Furthermore, as the investor dumps his assets, the monetary value also drops making the indices of correlation among the foreign exchange market, the stock market, and the bond market are all adjusted to indicate positive values. Accordingly, with the energy price on the hiking, ROI of each of these three capital markets is solved as follows:

ROI of Stock Market=Historical ROI of Stock Market+Historical ROI of the Bond×(0.8)+Historical ROI of Foreign Exchange Market×(0.3);

ROI of Bond Market=Historical ROI of Stock Market×(0.8)+Historical ROI of the Bond+Historical ROI of Foreign Exchange Market×(0.6); and

ROI of Foreign Exchange Market=Historical ROI of Stock Market×(0.3)+Historical ROI of the Bond×(0.6)+Historical ROI of Foreign Exchange Market.

The wealth management education system 1 may store the matrix of correlation parameters in relation to each economic event for the investor to retrieve the matrix correlation parameters as adjusted by referring to the table, or store functions corresponding to each economic event to operate the functions to solve the matrix of correlation parameters as adjusted.

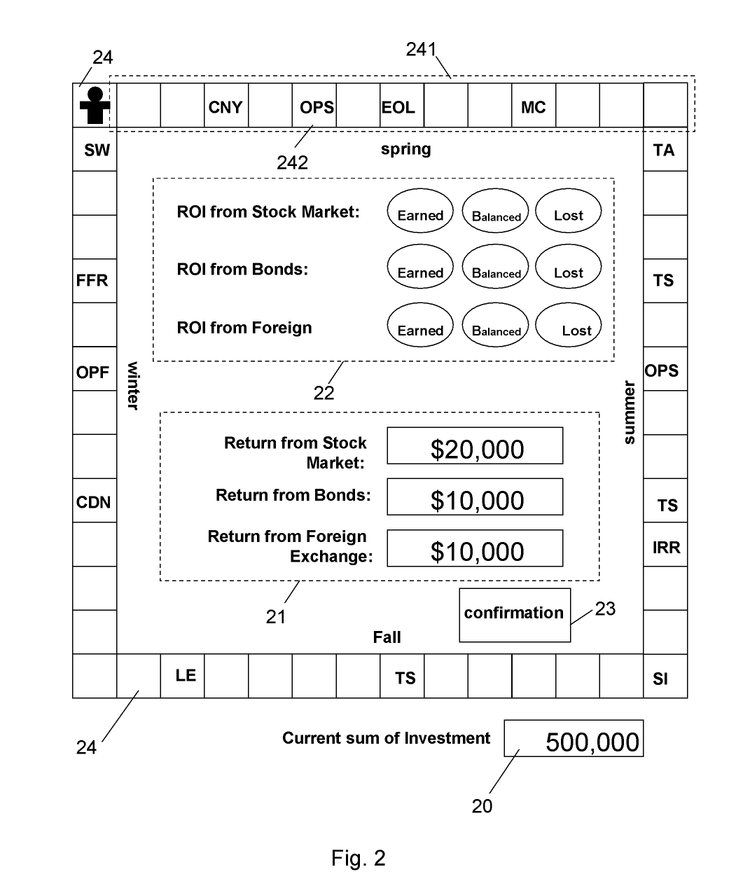

Referring to FIG. 2, a visualized user interface 2 corresponds to the wealth management education system 1 illustrated in FIG. 1. The visualized user interface 2 displays a column 20 of the sum available for the investor to make investments; a column 21 respectively for the investment amounts to be made in the stock market, the foreign exchange market, and the bond market; a column 23 respectively showing ROI of the stock market, ROI of the foreign exchange market, and ROI of the bond market; a confirmation key 23; and fifty-two economic events display areas 24. Each area 24 represents a week and fifty-two areas 24 make a total of fifty-two weeks of one year, and thirteen continuous areas 24 are grouped for one season to make four seasons of one year. The user starts with an area 240. The wealth management education system 1 selects multiple economic events pseudo-randomly according to the selection criterion to distribute them among those fifty-two areas 24 and displays each event in its respective area. In FIG. 2, there are 12 economic events displayed in sixteen areas, such as Chinese New Year (CNY), oil price soaring (OPS), election of legislator (EOL), mining casualty (MC), terrorist attack (TA), interest rate reduction (IRR), local election (LE), typhoon striking (TS), oil price falling (OPF), coup d'etat in neighboring (CDN), suspected inflation (SI), financial forecast rising (FFR), financial forecast falling (FFF), severe weather (SW).

Starting from area 240, the user may process each time thirteen areas before him depending on the current area he's at, i.e., up to Area 241 as illustrated. The user respectively enters into Column 21 investment amounts to be made in the stock market, the bond market, and the foreign exchange market and presses the confirmation key 23 to trigger off the wealth management education system 1 to decide at random the next area to go to. For example, if Area 242 is decided as the next area to go to, an economic event described as “oil price soaring” is designated to Area 242. Accordingly, the wealth management education system 1 estimates historical returns of investment respectively for those three capital markets based on historical prices for a period between the end of January and early February of SP500 (representing the stock market), 10-year US Government bond (representing the bond market), and US$ Indices (representing the foreign exchange market); parameters of matrices of correlation of the stock market, the bond market, and the foreign exchange market are then adjusted according to the economic event of “oil price soaring”; each ROI for these three capital markets at the time the economic event takes place is solved to highlight display the status of “Earned”, “Balanced”, or “Lost” to advise the investor whether the investment will be a success or not. Finally, the sum of investment available to the user is updated according to the investment amount and ROI for each of those three capital markets. If the user goes to an area in absence of any economic event, the wealth management education system 1 will estimate each historical ROI for each of those three capital markets based on the respective historical prices closed during the period of the end of January and early February; and the historical ROI estimated for each of those three capital markets becomes the final ROI for solving the amount of investment to be made in each market.

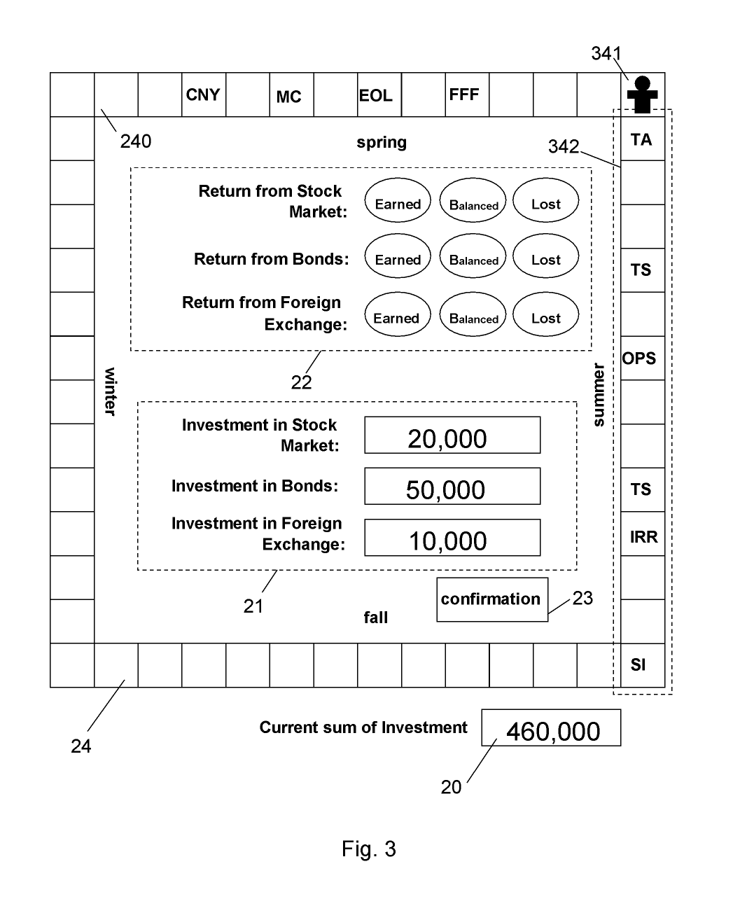

Now referring to FIG. 3 for another visualized user interface of the preferred embodiment of the wealth management education system 1 of the present invention, a visualized user interface 3 differs from the visualized user interface hat as illustrated in FIG. 2 rests in that the visualized user interface 3 displays only those economic events designated to those preceding areas and the coming thirteen areas terminated at area 342 from area 341 where the user's current area is at.

All these economic events relate to those the user may run into in the real situation. Therefore, to learn how to develop investment skills through the present invention, the user may repeat operating the wealth management education system 1 to observe fluctuations of each capital market and impacts from each economic event upon the capital market and practice how to make optimal allocation of the amount of investment for each capital market to cash in higher returns of investment.

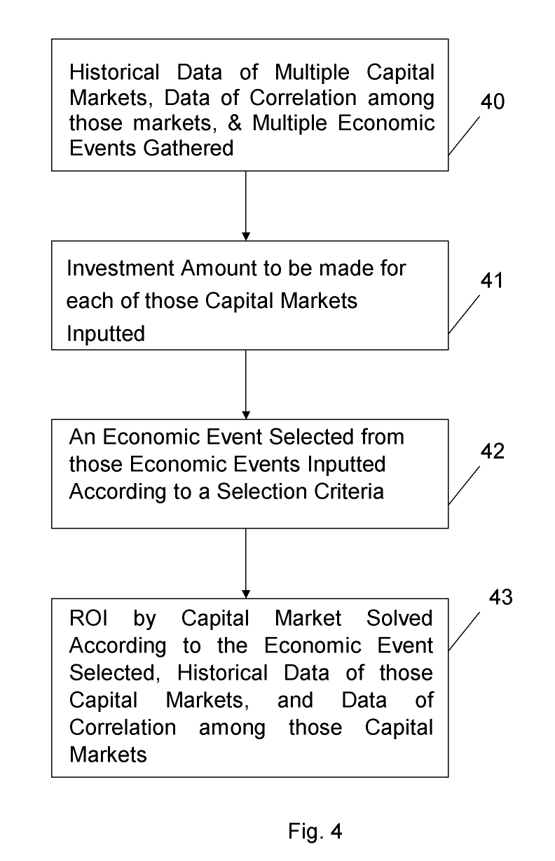

A flow chart is given in FIG. 4 describing the process applicable to the wealth management education system 1 as illustrated in FIG. 1 includes the following steps:

Step 40: Historical data 101 of multiple capital markets, correlation data 102 among those markets, and multiple economic events 103 are provided.

Step 41: Investment amount 111 to be made for each of those capital markets are inputted.

Step 42: An economic event 14 is selected from those economic events 103 inputted according to a selection criterion.

Step 43: ROI of each capital market is solved according to the economic event 14 selected, historical data 101 of those capital markets, and correlation data 102 among those capital markets.

Those multiple capital markets are preferred to include stock market, bond market, foreign exchange market, raw materials market and/or real estate market. Those historical data 101 are preferred to those representative data of each capital market; for example, SP500 historical prices to represent historical data of the stock market; ten-year US Government bond to represent historical data of the bond market; and US$ indices to represent historical data of the foreign exchange market. Those economic events 103 are preferred to include weather events, political events, financial/economic events, psychological factors and/or strategic factors. For example, weather events may include mining disaster, typhoon striking, heat waves, flooding or draught; political events may include election, coup d'etat, or terrorist attack; financial/economic events may include interest rate rise by FOMC, oil price soaring or publishing financial statements by leading companies in the industry involved; and psychological and strategic factors may include Soros hot money, and expectations on the market environment among the general public, adventurers, or investors.

The selection criterion is preferred to include selection of certain events out of those economic events 103 at random or pseudorandom. Before selecting an event pseudo-randomly, several economic events are first selected from those economic events 103; and an economic event is then selected at random from those economic events surviving the preliminary selection. Preemptive conditions for selecting the event pseudo-randomly may be defined by season, time, or month. For example, if the simulated season executed by the system is summer, item of “typhoon striking” from weather events will have a better chance to be selected as a pre-elected economic event. The wealth management education system 1 may further include a visualized user interface as applicable to provide its user to operate the wealth management education system 1.

A visualized user interface may be further provided to the method of the present invention to allow a user to operate the wealth management education system of the present invention through the visualized user interface.

It is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is:

1. A wealth management education system comprising:
a storage unit, for containing historical data of multiple capital markets, correlation data among said capital markets, and multiple economic events;
an input unit, for entering a sum of investment to be made in those capital markets by a user;
an event selection unit, for selecting one economic event from said economic events according to a selection criterion; and
an ROI computation unit to respectively solve ROI and amount of return for each of said capital market according to said selected economic event, historical data of said capital markets, and said correlation data among said capital markets.

2. The wealth management education system as claimed in claim 1, wherein said economic events include weather events, political events, financial/economic events, psychological or strategic factors that may cause fluctuations to those capital markets.

3. The wealth management education system as claimed in claim 1, wherein said selection criterion is related to select an economic event at random.

4. The wealth management education system as claimed in claim 1, wherein said selection criterion is related to select an economic event pseudo-randomly.

5. The wealth management education system as claimed in claim 4, wherein said selection criterion is related to select pre-selected economic events from said multiple economic events, and one economic event is then selected at random from said pre-selected economic events.

6. The wealth management education system as claimed in claim 1, wherein said capital markets include stock market, bond market, foreign exchange market, raw materials market or real estate market.

7. The wealth management education system as claimed in claim 1, further comprising a visualized user interface to allow a user to operate said wealth management education system through said visualized user interface.

8. The wealth management education system as claimed in claim 1, wherein said correlation data includes a correlation matrix.

9. The wealth management education system as claimed in claim 1, wherein said ROI computation unit solves a historical ROI for each of said capital markets based on historical data of said capital market, and then solves the ROI for each of those capital markets based on said historical ROI and said correlation data.

10. The wealth management education system as claimed in claim 8, wherein said ROI computation unit adjusts the parameters in the correlation matrix according to said selected economic event.

11. A wealth management education method comprising the steps of:
providing historical data of multiple capital markets, correlation data among said capital markets, and multiple economic events;
inputting investment amount to be made for each of said capital markets;
selecting an economic event from said economic events inputted according to a selection criterion; and
solving ROI of each of said capital markets according to the selected economic event, historical data of said capital markets, and said correlation data among said capital markets.

12. The wealth management education method as claimed in claim 11, wherein said economic events include weather events, political events, financial/economic events, psychological or strategic factors that may cause fluctuations to said capital markets.

13. The wealth management education method as claimed in claim 11, wherein said selection criterion is related to select an economic event at random.

14. The wealth management education method as claimed in claim 11, wherein said selection criterion is related to select an economic event pseudo-randomly.

15. The wealth management education method as claimed in claim 14, wherein said selection event is related to select multiple pre-selected economic events from said economic events, and then select an economic event from said pre-selected economic events at random.

16. The wealth management education method as claimed in claim 11, wherein said capital markets include stock market, bond market, foreign exchange market, raw materials market or real estate market.

17. The wealth management education method as claimed in claim 11, further comprising a step of providing a visualized user interface to allow a user to operate the wealth management education system through said visualized user interface.

18. The wealth management education method as claimed in claim 11, wherein said correlation data includes a correlation matrix.

19. The wealth management education method as claimed in claim 11, further comprising a step of solving a historical ROI for each of said capital markets based on historical data of said capital market, and solving the ROI for each of said capital markets based on said historical ROI and said correlation data.

20. The wealth management education method as claimed in claim 18, further comprising a step of adjusting said correlation parameters in the matrix according to said selected economic event.
